(19) United States
(12) Patent Application Publication
(10) Pub. No.: US 2011/0211259 A2
(43) Pub. Date: Sep. 1, 2011

(54) DIFFUSION PLATE WITH HIGH DIFFUSION QUALITY

(75) Inventors: Chun-Wei Wang, Taoyuan County (TW); Wen-Feng Cheng, Taoyuan County (TW); Chih-Wei Huang, Taoyuan County (TW)

(73) Assignee: Entire Technology Co., Ltd., Taoyuan County (TW)

(21) Appl. No.: 12/210,267

(22) Filed: Sep. 15, 2008

(30) Foreign Application Priority Data
Jun. 3, 2008 (TW) 097120535

(51) Int. Cl. G02B 5/02

(52) U.S. Cl. 359/599; 362/620

(57) ABSTRACT

A diffusion plate including a structured surface is provided. There are a lot of concave structures disposed on the structured surface. Each concave structure, with at least two opposite first sides and at least two opposite second sides, includes at least two first curved surfaces and at least two second curved surfaces. The first curved surfaces and the second curved surfaces are extended from the first sides and the second sides respectively. In addition, each concave structure adjoins at least one other concave structure, and the shape of a neighboring portion of two said adjoining concave structures is curved.

### BACKGROUND OF THE INVENTION

1. Field of the Invention

The present invention relates to a diffusion plate. More particularly, the present invention relates to a diffusion plate with pluralities of concave structures.

2. Description of the Prior Art

Nowadays, technologies which pertain to the liquid crystal display (LCD) make remarkable progress, which leads to the drop in price of the LCD and the fact that the display quality of the LCD catches up to the conventional CRT display gradually. Generally speaking, an LCD includes a backlight module and an LCD panel. The backlight module provides light rays for the LCD to display, and the LCD panel can control the penetration of light rays by means of varying the arrangement of the liquid crystal thereof. Please refer to FIG. 1 for a schematic view of an LCD already in the market. The LCD 1 includes a backlight module 11 and an LCD panel 12. The backlight module 11 includes a reflective bowl 111, pluralities of light sources 112, a diffuser plate 113 and a brightness enhancement film 114. The light sources 112 are disposed in the reflective bowl 111. The diffuser plate 113 is used to diffuse the light rays emitted by the light sources 112, while the brightness enhancement film 114 is used to condense the diffused light rays.

The diffuser plate 113 consists of a transparent material such as polymethyl methacrylate, polycarbonate or polyethylene terephthalate, and there are pluralities of light diffusion particles 115 spread therein. The refractive index of the light diffusion particles 115 is different from that of the transparent material of the diffuser plate 113. Therefore, the deflection occurs when the light rays pass through the interface between the diffuser plate 113 and the light diffusion particles 115 so as to achieve the light diffusion effect.

When the LCD is placed in a living room, being used as a TV, it should allow not only the user in front of the display (e.g. position A) but the user in the side of the display (e.g. position B) to watch it clearly. Therefore, the diffusion angle of the LCD has to be big enough. On the contrary, when the LCD is placed on an office desk to be used as a computer display, it is mainly designed to allow the user in front of the display (e.g. position A) to watch it clearly and therefore the diffusion angle of the LCD can be relatively smaller. However, the way of the spreading of the light diffusion particles 115 within the diffuser plate 113 is irregular, which leads to the problem that the diffusion angle of light can not be controlled accurately.

Therefore, it is of concern for those skilled in the art to control the diffusion angle accurately. The U.S. Pat. No. 7,320,538 has disclosed an optical film 2 as shown in FIG. 2. The optical film 2 includes a body 21 and a structured surface 22, which is disposed upon the body 21 on the strength of an adhesion layer 23. There are a lot of concave structures 24 disposed on the structured surface 22. Each concave structure 24 includes four surfaces, i.e. two first surfaces 24a and two second surfaces 24b (as depicted in FIG. 3A). Next, please refer to FIG. 3A-FIG. 3C simultaneously. FIG. 3B is a BB section of FIG. 3A, and FIG. 3C is a CC section of FIG. 3A. The included angle α₁ is the angle between the second surface 24b and the imaginary surface 25, and the included angle β1 is the angle between the first surface 24a and the imaginary surface 25.

Please continue to refer to FIG. 3B. The direction of the light ray I₁₁ is parallel to the normal vector of the second surface 24b so that the light ray I₁₁ can penetrate the second surface 24b without deflection. Moreover, there is an included angle δ₁₂ between the direction of the light ray I₁₂ and the normal of the second surface 24b so that the deflection occurs when the light ray I₁₂ passes through the second surface 24b. Furthermore, the included angle δ₁₃ between the direction of the light ray I₁₃ and the normal of the second surface 24b is bigger than the critical angle δ_{c} so that the total internal reflection occurs, which means the light ray I₁₃ cannot pass through the second surface 24b.

Next, please refer to FIG. 3B and FIG. 3C. The directions of the light rays I₂₁, I₂₂ and I₂₃ in reference with section surface in FIG. 3C are identical to those of the light rays I₁₁, I₁₂ and I₁₃ in reference with section surface in FIG. 3B respectively. However, the normal vectors of the first surface 24a and the second surface 24b are not identical. Therefore, the directions of the light rays I₂₁, I₂₂ and I₂₃ after passing through the first surface 24a are not identical to those of the light rays I₁₁, I₁₂ and I₁₃ after passing through the second surface 24b respectively.

Comparing FIG. 3B and FIG. 3C, those skilled in the art must have understood that the diffusion angle of the light rays passing through the concave structures can be adjusted by means of varying the included angles α₁ and β₁.

However, there is still a significant problem in the present optical film 2. Please refer to FIG. 4, the included angles between the directions of light rays I₃₁, I₃₂, I₃₃ and the normal vector of the first surface 24a respectively are identical, 62, which means the directions of light rays I₃₁, I₃₂ and I₃₃ are parallel after passing through the first surface 24a. Therefore, ideal diffusion effect cannot be achieved. As a result, users may be disappointed with the unbalance of the brightness of the LCD, which leads to the decrease in desire to purchase the LCD. Moreover, refer to FIG. 2, the neighboring portion 244 of two adjacent concave structures 24 is a sharp angle. Therefore, it is apt to scratch the brightness enhancement film 114 as depicted in FIG. 1 or other optical film when it is disposed upon the structured surface 22.

### SUMMARY OF THE INVENTION

The present invention provides a diffusion plate, which can control the diffusion angle of light and can diffuse the light rays more uniformly.

To achieve the foregoing and other objects, the present invention provides a diffusion plate. The diffusion plate includes a structured surface, which has pluralities of concave structures disposed thereon. Each concave structure, with at least two opposite first sides and at least two opposite second sides, includes at least two first curved surfaces and at least two second curved surfaces, while the first curved surfaces and the second curved surfaces are extended from the first sides and the second sides respectively. Moreover, each concave structure adjoins at least one other concave structure, and the shape of a neighboring portion of two adjoining concave structures is curved.

In the present diffusion plate, an area defined by said first sides and said second sides is trapezoid, rectangular, diamond or square.

In the present diffusion plate, the first curved surfaces and the second curved surfaces intersect to form an intersection point.

In the present diffusion plate, each concave structure further includes a bottom surface, which is connected with the first curved surfaces and the second curved surfaces. Besides, the bottom surface is flat or curved.

In the present diffusion plate, further includes a body disposed under the structured surface. There are pluralities of light diffusion particles, which the refractive index thereof is different from that of the body, spread therein.

In the present diffusion plate, further includes a substrate disposed under the body, in which UV absorber is added therein.

In the present diffusion plate, two said first curved surfaces are symmetric, and two said second curved surfaces are symmetric.

To achieve the foregoing and other objects, the present invention provides a diffusion plate. The diffusion plate includes a structured surface, which has pluralities of concave structures disposed thereon. Moreover, each concave structure, with at least two opposite first sides and at least two opposite second sides, includes a first curved surface and two second curved surfaces, while two said second curved surfaces are extended from two said first sides and both sides of the first curved surface are connected to two said second surfaces. Besides, each concave structure adjoins at least one other concave structure, and the shape of a neighboring portion of two adjoining concave structures is curved. Furthermore, two said second curved surfaces are symmetric.

In the concave structures of the present invention, the tangent slopes of different positions on the first and the second curved surfaces are not always identical. Therefore, parallel light rays become inparallel with each other after passing through the first or the second curved surfaces. Due to the present concave structures, the diffusion plate of the present invention can diffuse the light rays more uniformly.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an LCD already in the market.

FIG. 2 is an optical film disclosed in the U.S. Pat. No. 7,320,538.

FIG. 3A is a top view of a concave structure depicted in FIG. 2; FIG. 3B is a BB section of FIG. 3A; FIG. 3C is a CC section of FIG. 3A.

FIG. 4 shows the direction of the light rays after passing through the first curved surface of the concave structure.

FIG. 5 is a section view of a diffusion plate of the first embodiment of the present invention.

FIG. 6 is a partial perspective view of a structured surface.

FIG. 7A is a top view of a concave structure of the first embodiment; FIG. 7B is a BB section of FIG. 7A; FIG. 7C is a CC section of FIG. 7C.

FIG. 8 is a deployment diagram of the elements when undergoing an optical simulation.

FIG. 9A and FIG. 9B shows the results of the optical simulation.

FIG. 10 is a section view of two adjacent concave structures.

FIG. 11A-FIG. 11C shows other forms of concave structures of the first embodiment.

FIG. 12A is a top view of another form of a concave structure of the first embodiment; FIG. 12B is a BB section of FIG. 12A; FIG. 12C is a CC section of FIG. 12A.

FIG. 13 is a front view of a diffusion plate of the second embodiment of the present invention.

FIG. 14 is a top view of a structured surface.

FIG. 15A is a top view of a concave structure of the second embodiment of the present invention; FIG. 15B is a BB section of FIG. 15A; FIG. 15C is a CC section of FIG. 15A.

FIG. 16 is a section view of two adjacent concave structures of the second embodiment.

FIG. 17A-FIG. 17C shows other forms of concave structures of the second embodiment.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

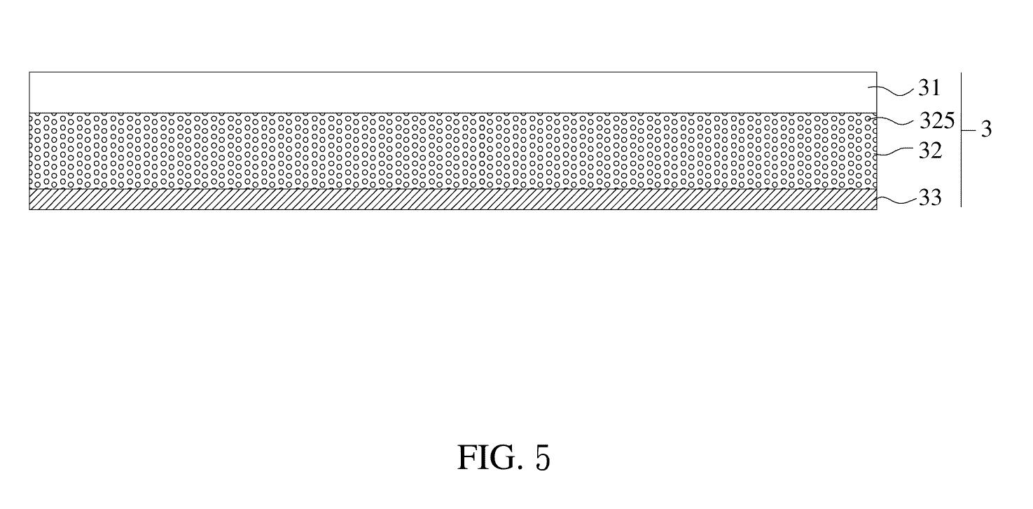

Please refer to FIG. 5 for a front view of a diffusion plate of the first embodiment of the present invention. The diffusion plate 3 includes a structured surface 31, a body 32 and a substrate 33. The body 32, which has pluralities of light diffusion particles 325 spread therein, is disposed under the structured surface 31. The refractive index of the light diffusion particles 325 is different from that of the body 32. Therefore, the deflection occurs when light passes through the interface between the body 32 and the light diffusion particles 325 so as to achieve the light diffusion effect. Moreover, the substrate 33, where the UV absorber is added therein, is disposed under the body 32. The substrate 33, therefore, can absorb UV so as to alleviate the aging of the diffusion plate 3. In addition, the UV absorber can also added into the structured surface 31 as needed.

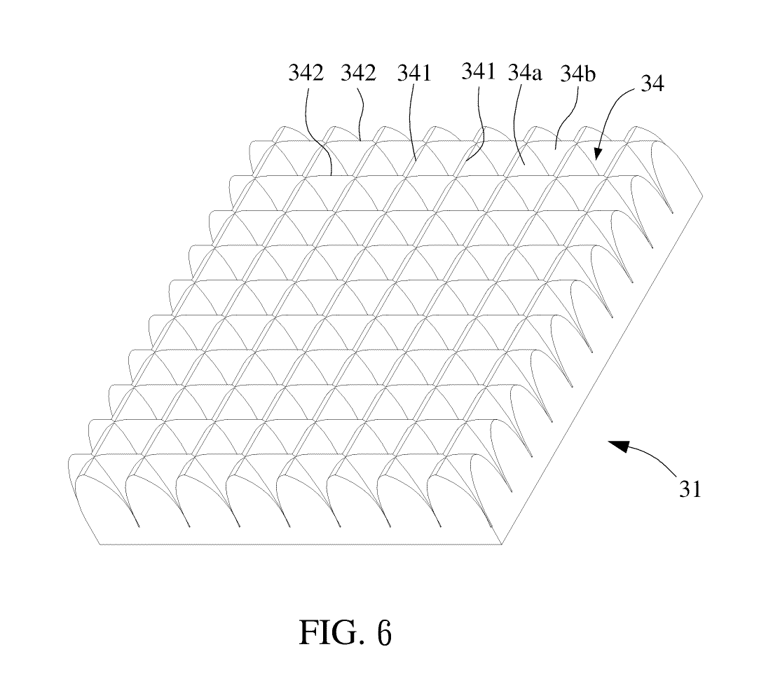

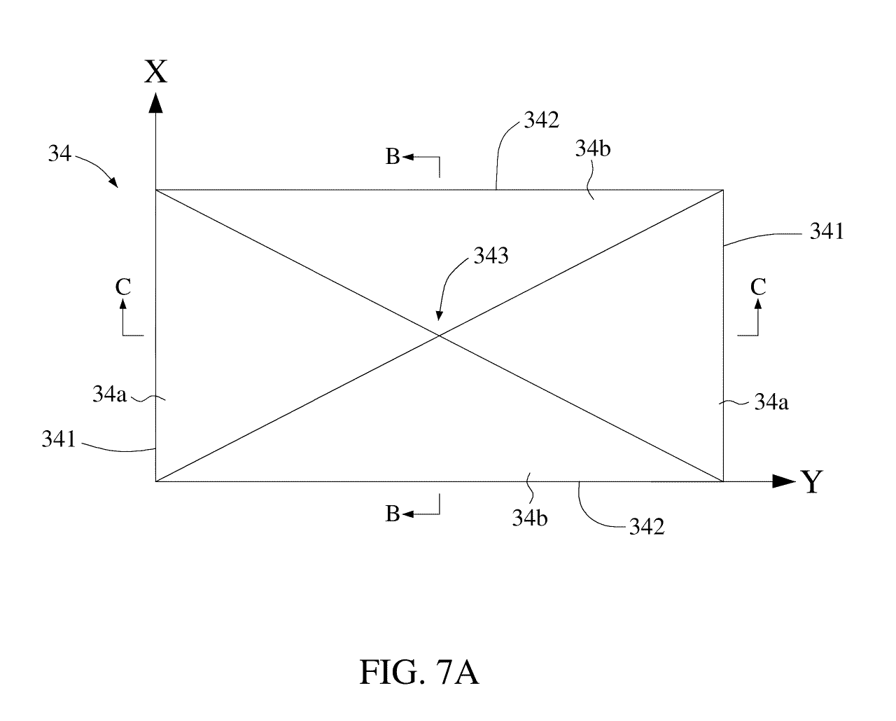

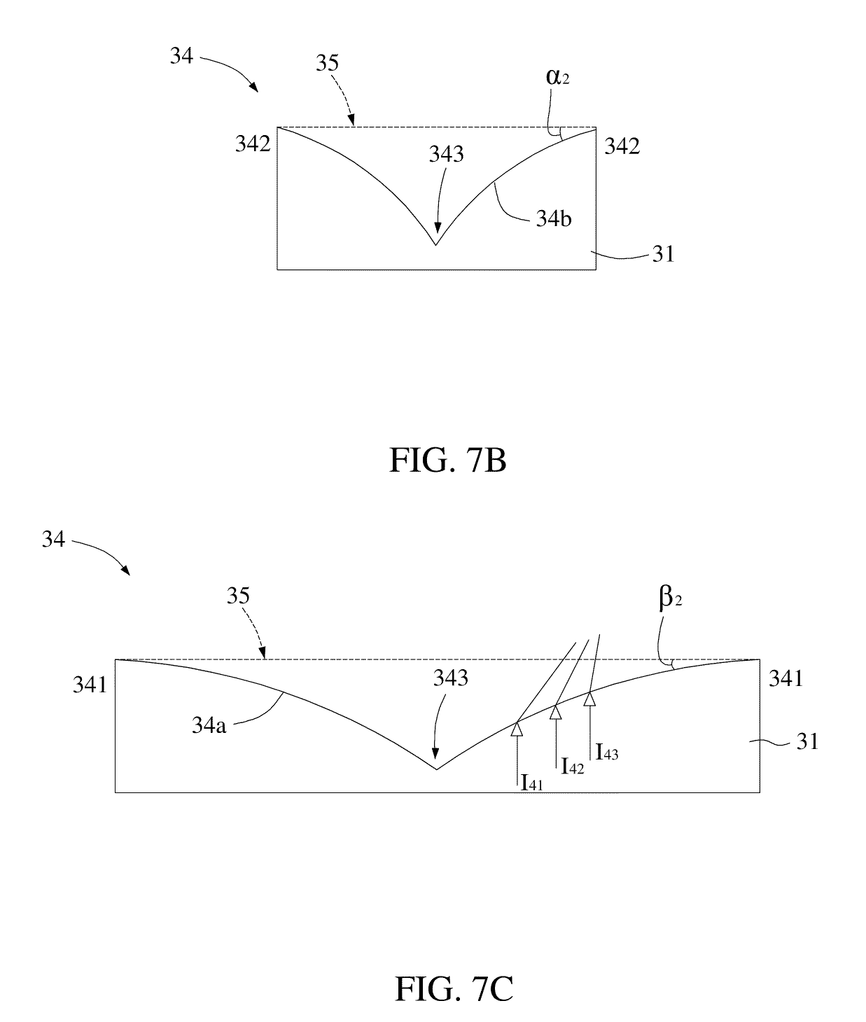

Next, please refer to FIG. 6 and FIG. 7A-FIG. 7C simultaneously. FIG. 6 is a partial perspective view of a structured surface, FIG. 7A is a top view of a concave structure of the first embodiment, FIG. 7B is a BB section of FIG. 7A, and FIG. 7C is a CC section of FIG. 7C. There are pluralities of concave structures 34 disposed on the structured surface 31. Each concave structure 34 has two opposite first sides 341 and two opposite second sides 342. Furthermore, each concave structure 34 includes two first curved surfaces 34a and two second curved surfaces 34b, in which the first curved surfaces 34a and the second curved surfaces 34b are extended from the first sides 341 and the second sides 342 respectively. In the present embodiment, the two first curved surfaces 34a are symmetric, and the two second curved surfaces 34b are symmetric, too. Moreover, the first curved surfaces 34a and the second curved surfaces 34b intersect to form an intersection point 343. In addition, there is an included angle α₂ between the second curved surface 34b and the imaginary surface 35, and there is also an included angle β₂ between the first curved surface 34a and the imaginary surface 35, while the imaginary surface 35 is defined by the two first sides 341 and the two second sides 342.

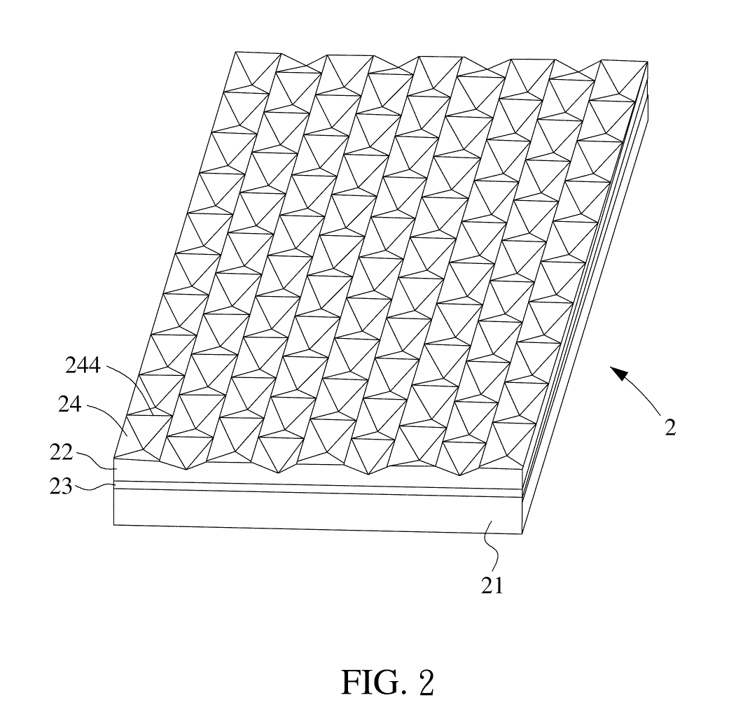

Please continue to refer to FIG. 7C. Because the tangent slope of different positions on the first curved surface 34a varies as the height of the point differs, the directions of the parallel light rays I₄₁, I₄₂ and I₄₃ become inparallel with each other after passing through the first curved surface 34a. Moreover, similar effect occurs when light rays pass through the second curved surface 34b. Therefore, the concave structures 34 of the present embodiment, compared with the concave structures 24 as shown in FIG. 2, can diffuse the light more uniformly.

Furthermore, the designers of the diffusion plate 3 can also adjust the diffusion angle of light passing through the concave structures 34 by means of varying the included angle α₂ and β₂ or varying the tangent slope of different positions on the first curved surfaces 34a and the second curved surfaces 34b.

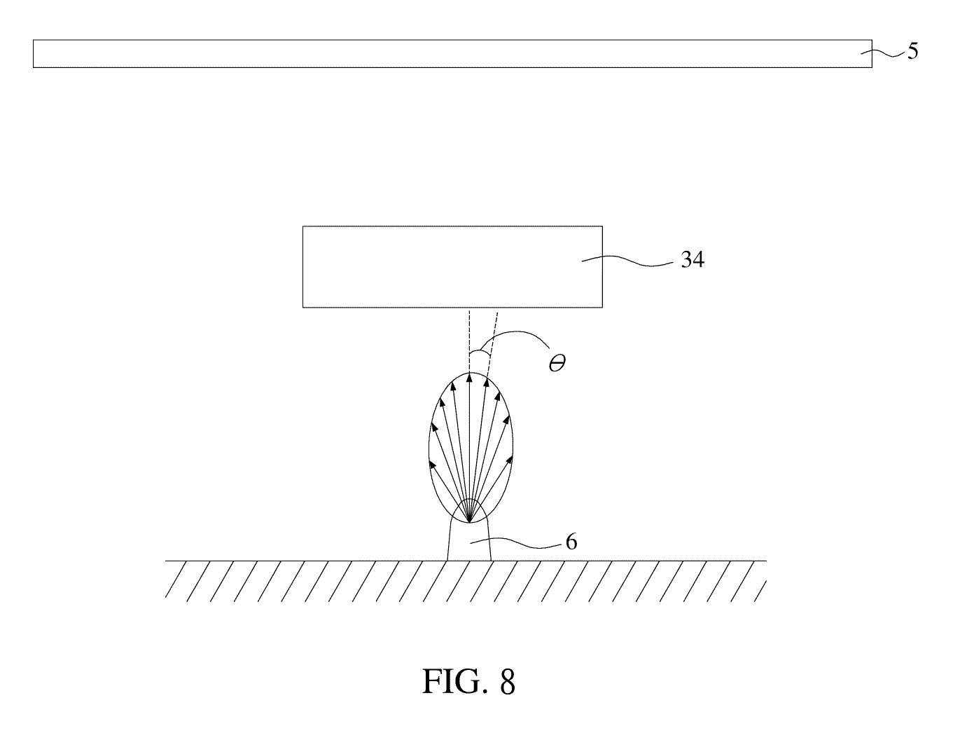

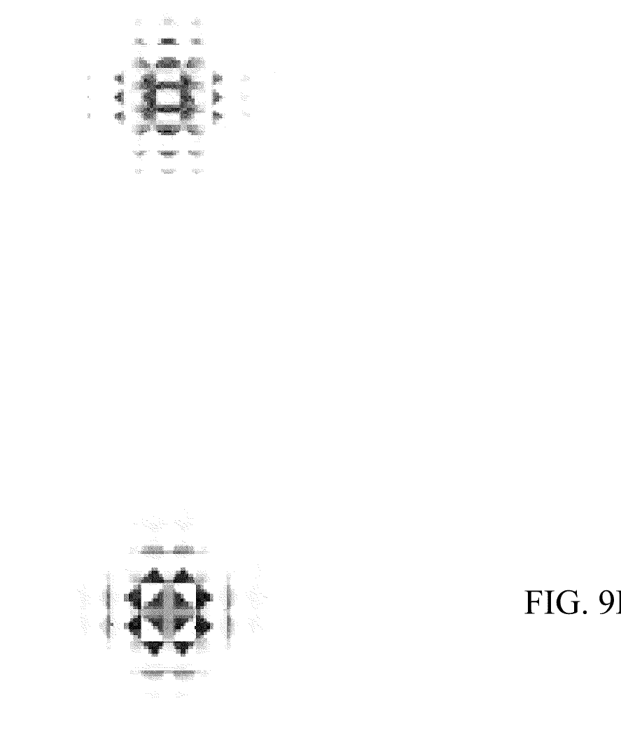

Next, the present concave structure 34 undergoes an optical simulation. Please refer to FIG. 8 for a deployment diagram of the elements when undergoing the optical simulation. The concave structure 34 is disposed between a light source 6 and a screen 5, and the light source 6 projects a shadow on the screen 5 after passing through the concave structure 34. The result is as shown in FIG. 9A. In the optical simulation, the light source 6 is an LED, in which the relationship of the intensity of light emitted thereby and the included angle θ between the light and the vertical direction is as follow:
I=A×cos θ, in which “I” stands for the intensity of light, and “A” is a constant.

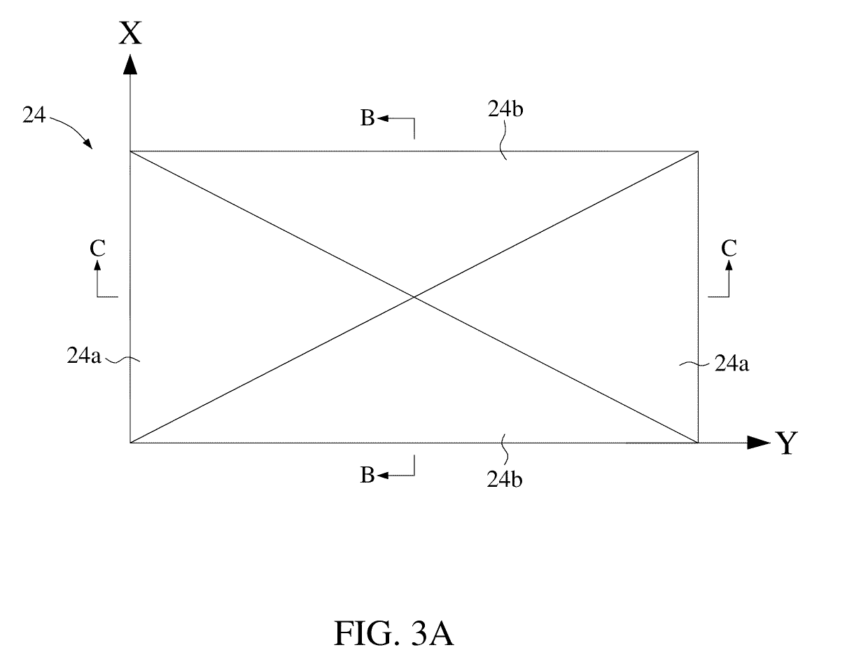

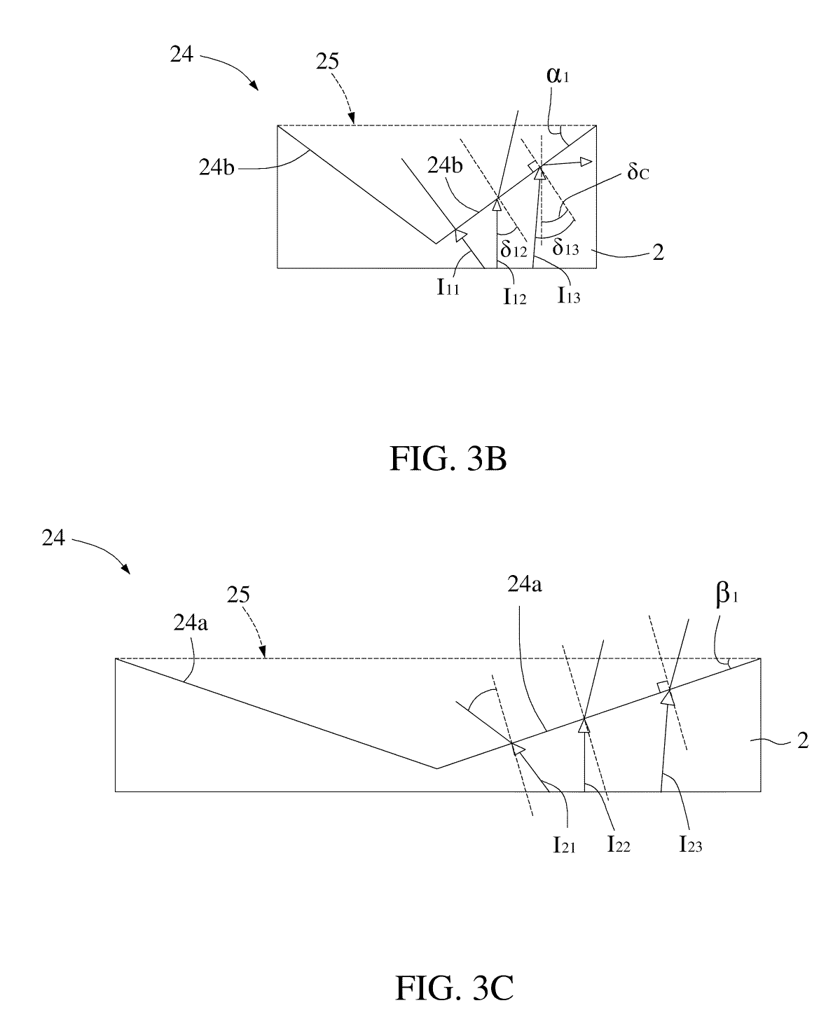

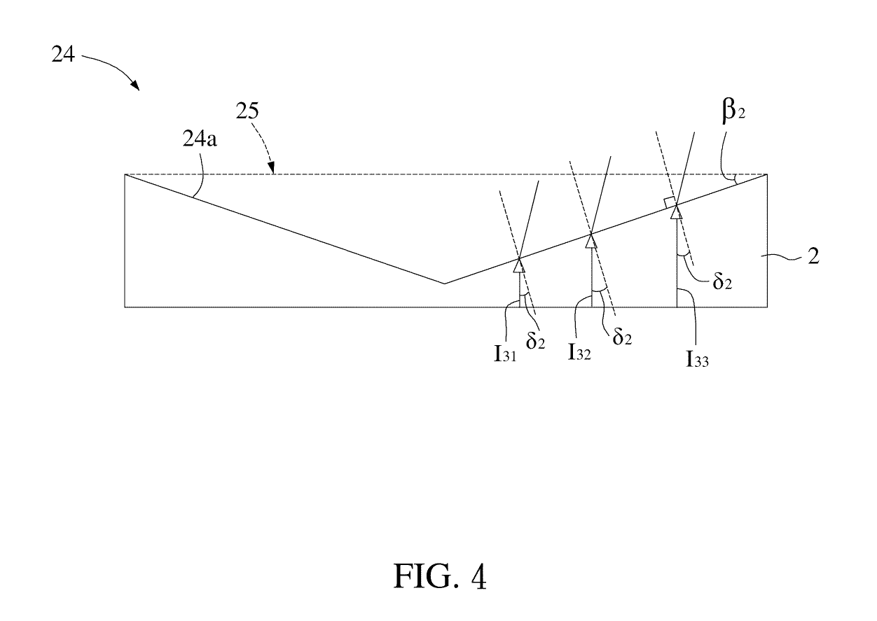

Then, the concave structure 34 is replaced by the concave structure 24 as shown in FIG. 3A, undergoing the same optical simulation again. The result is as shown in FIG. 9B. In FIG. 9A and FIG. 9B, the deeper the color is, the stronger the brightness is. The uniformity in the FIG. 9A is approximately 78%, and the uniformity in the FIG. 9B is approximately 69.5%, in which the uniformity means: (maximum brightness−minimum brightness)/maximum brightness. From FIG. 9A and FIG. 9B, those skilled in the art can easily find that the concave structure 34 of the present embodiment has better optical diffusion effect.

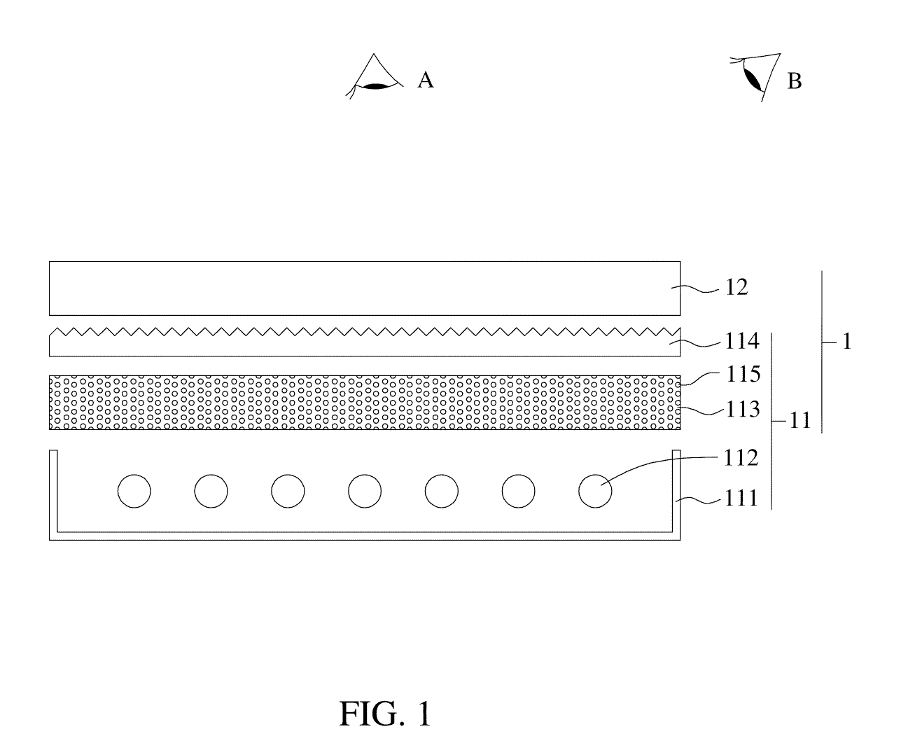

In summary, those skilled in the art can clearly understand that the LCD 1 has more uniform performance on the brightness when the diffuser plate 113 as shown in FIG. 1 is replaced by the diffusion plate 3 of the present embodiment.

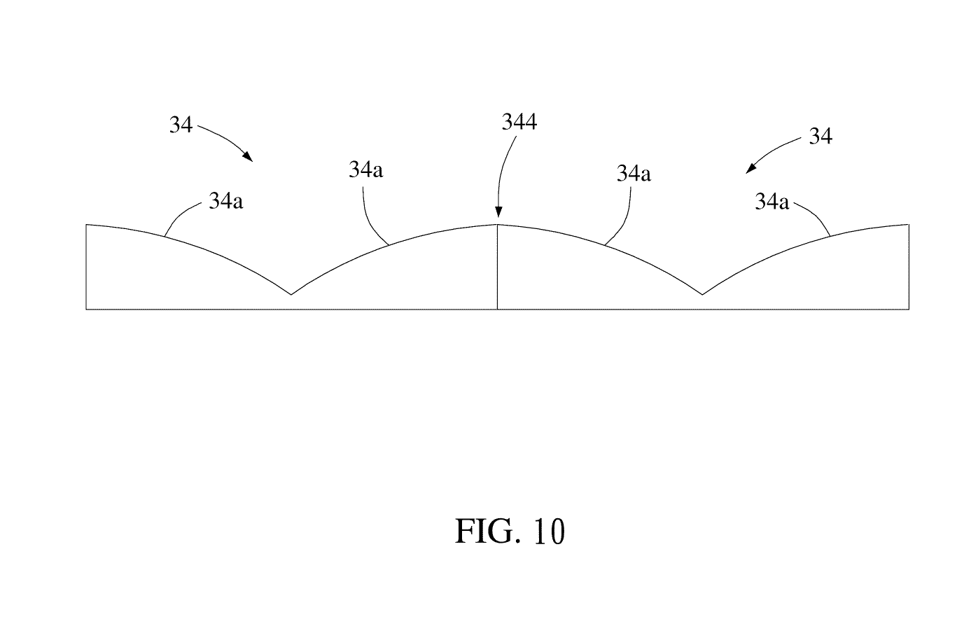

Next, please refer to FIG. 3A-FIG. 3C and FIG. 10. FIG. 10 is a section view of two adjacent concave structures. From FIG. 3A-FIG. 3C and FIG. 10, each concave structure 34 adjoins at least one other concave structure 34, and the shape of a neighboring portion 344 of two adjacent concave structures 34 is curved. Therefore, there is no sharp angle on the present structured surface 31. Though FIG. 10 only shows the neighboring portion 344 of two first curved surfaces 34a of the adjoining concave structures 34, the neighboring portion of two second curved surfaces 34b (as shown in FIG. 7A) of the adjoining concave structures 34 is also curved. The main reason of such design is that the brightness enhancement film 114 or other optical film is less apt to be scratched when placed upon the diffusion plate 3. Besides, the diffusion plate 3, for example, is formed by a mold, and the design of the curved neighboring portion 344 allows the diffusion plate 3 to be released from the mold more easily.

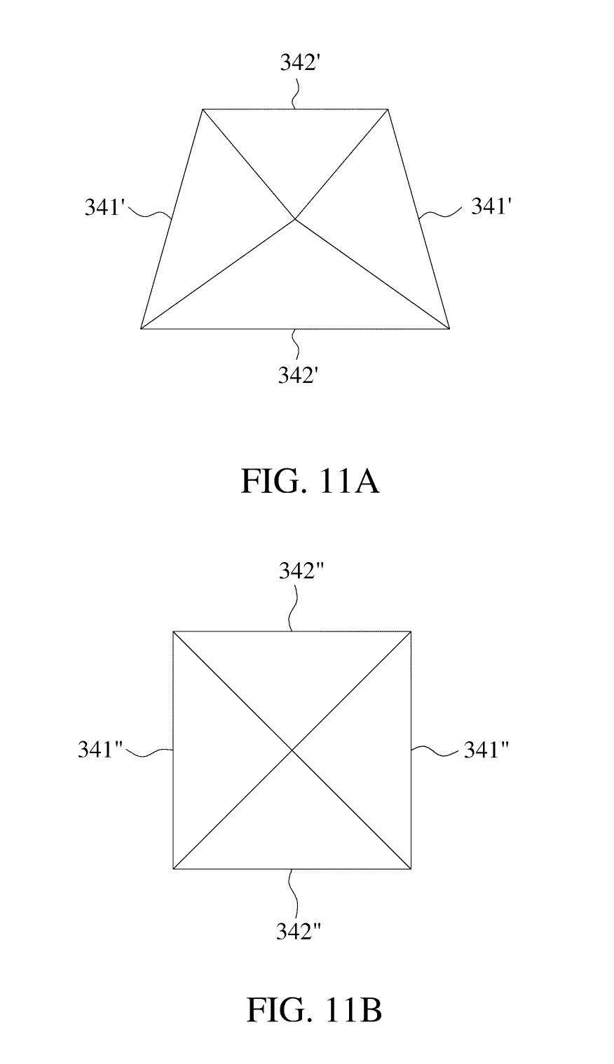

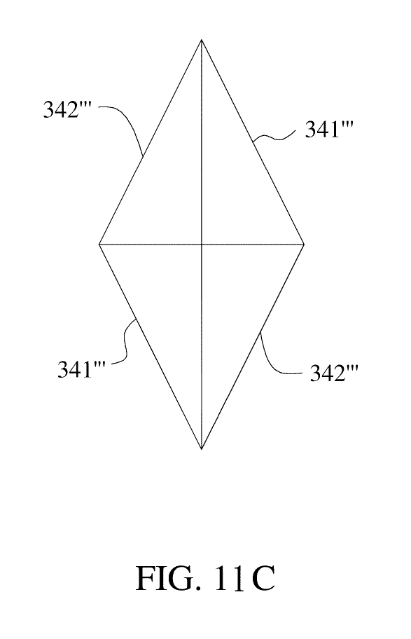

Note that the area defined by two first sides 341 and two second sides 342 is rectangular in the present concave structure 34. However, those skilled in the art can modify the area into other shape as needed. For example, as shown in FIG. 11A, the area defined by two first sides 341′ and two second sides 342′ is trapezoid. In addition, as shown in FIG. 11B, the area defined by two first sides 341″ and two second sides 342″ is square. Furthermore, as shown in FIG. 11C, the area defined by two first sides 341′″ and two second sides 342′″ is diamond.

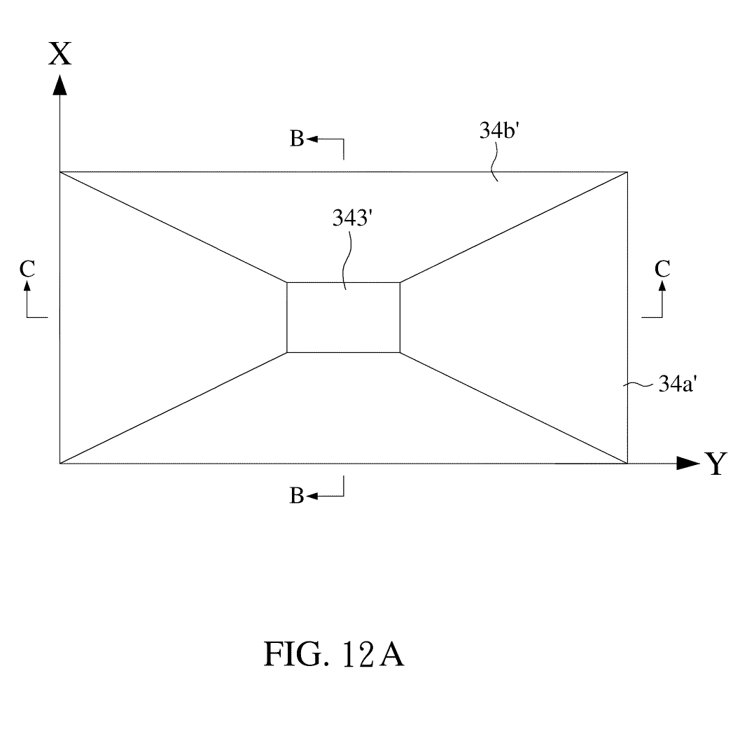

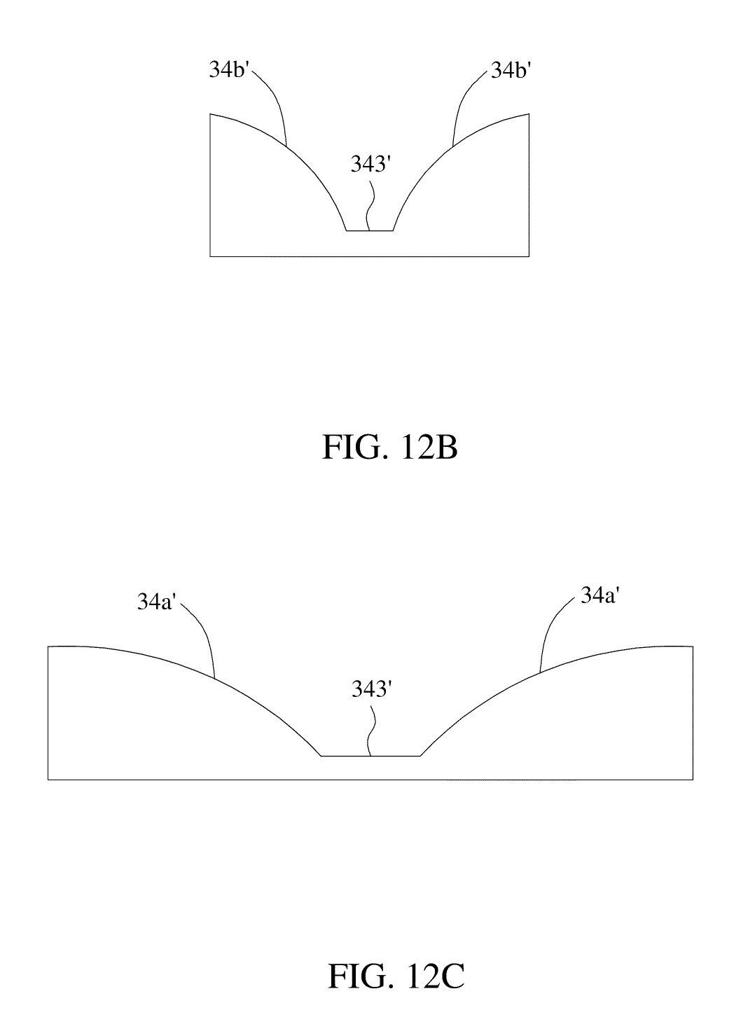

Besides, in the first embodiment, the first curved surfaces 34a and the second curved surfaces 34b intersect to form an intersection point 343. However, as shown in FIG. 12A-FIG. 12C, those skilled in the art can also design the first curved surfaces 34a′ and the second curved surfaces 34b′ to intersect to form a bottom surface 343′. In the FIG. 12B, the bottom surface 343′ is flat, yet those skilled in the art can vary the bottom surface 343′ to be curved.

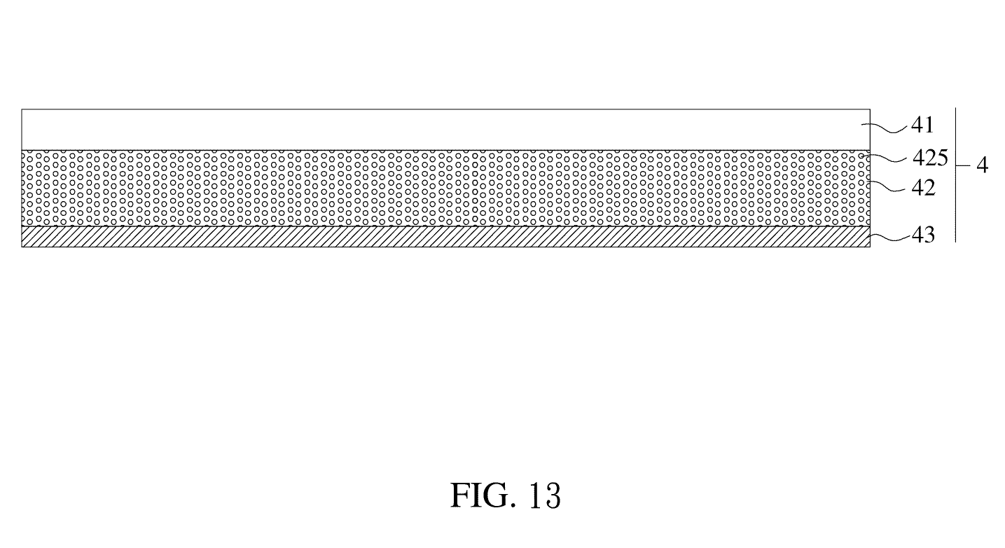

Please refer to FIG. 13 for a front view of a diffusion plate of the second embodiment of the present invention. The diffusion plate 4 includes a structured surface 41, a body 42 and a substrate 43. The body 42, which has pluralities of light diffusion particles 425 spread therein, is disposed under the structured surface 41. The refractive index of the light diffusion particles 425 is different from that of the body 42. Therefore, the deflection of light occurs when the light rays passes through the interface between the light diffusion particles 425 and the body 42 so as to achieve the light diffusion effect. In addition, the substrate 43, which has UV absorber added therein, is disposed under the body 42. Therefore, the substrate 43 can absorb UV and decrease the aging of the diffusion plate 4. Moreover, UV absorber can also be added in the structured surface 41 as needed.

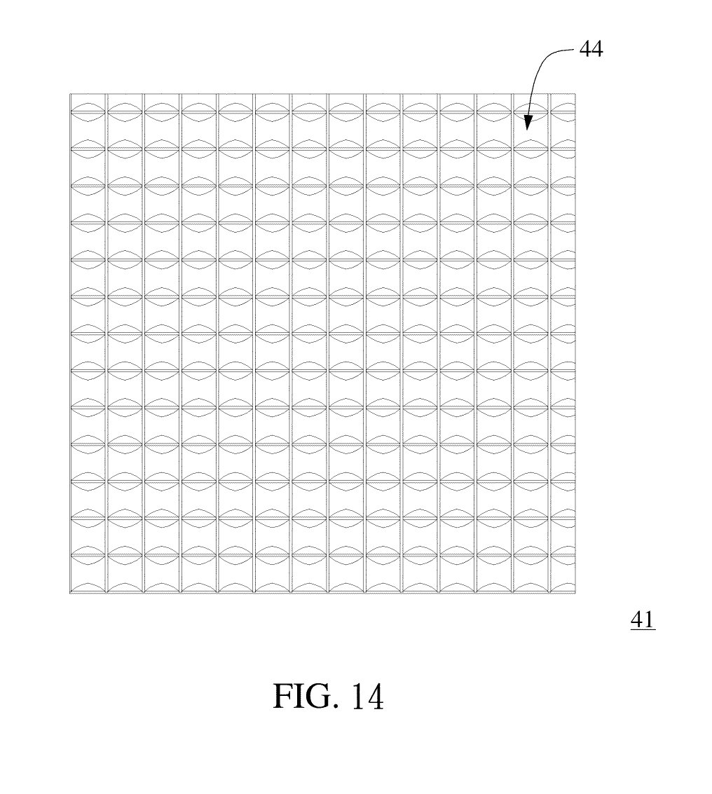

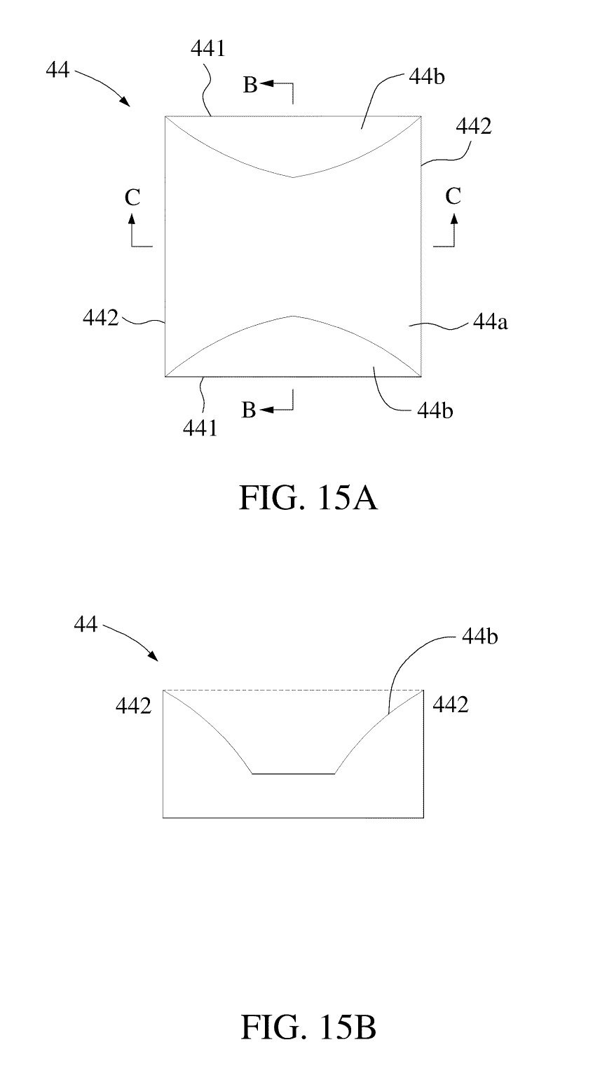

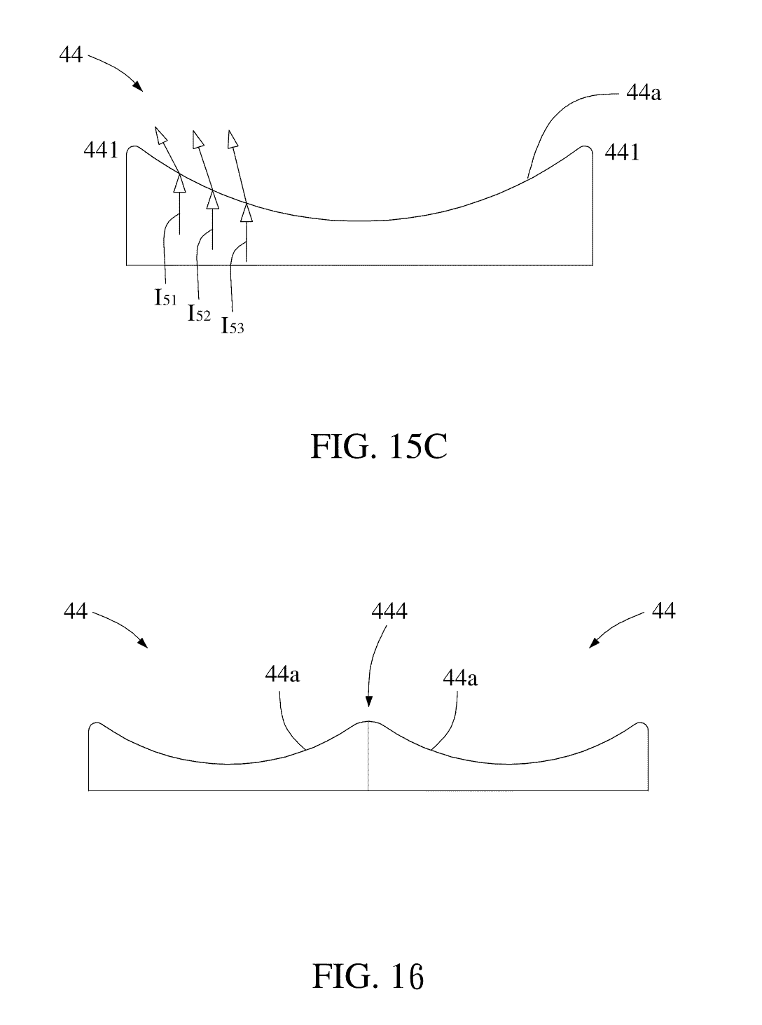

Please refer to FIG. 14 and FIG. 15A-FIG. 15C. FIG. 14 is a top view of a structured surface, FIG. 15A is a top view of a concave structure of the second embodiment of the present invention, FIG. 15B is a BB section of FIG. 15A, and FIG. 15C is a CC section of FIG. 15A. Each concave structure 44 has at least two opposite first sides 441 and at least two opposite second sides 442. Besides, each concave structure 44 further includes a first curved surface 44a and two second curved surfaces 44b, in which the second curved surfaces 44b are extended from the first sides 441, and both sides of first curved surface 44a are connected with two said second sides 442 respectively. Moreover, in the present embodiment, the two second curved surfaces 44b are symmetric.

Please continue to refer to FIG. 15C. Because the tangent slope of different positions on the first curved surface 44a varies as the height of the point differs, the directions of the parallel light rays I₅₁, I₅₂ and I₅₃ become inparallel with each other after passing through the first curved surface 44a. Therefore, the concave structures 44 of the present embodiment, compared with the concave structures 24 as shown in FIG. 2, can diffuse the light rays more uniformly.

Next, please refer to FIG. 16 for a section view of two adjacent concave structures of the second embodiment. From FIG. 16, each concave structure 44 adjoins at least one other concave structure 44, and the shape of the neighboring portion 444 of two adjacent concave structures 44 is curved. Though FIG. 16 only shows the neighboring portion 444 of two first curved surfaces 44a of the adjacent concave structures 44, the neighboring portion of two second curved surfaces 44b (as shown in FIG. 15A) of the adjacent concave structures 44 is also curved. The main reason of such designs is depicted in the first embodiment, and therefore it would not be depicted again hereinafter.

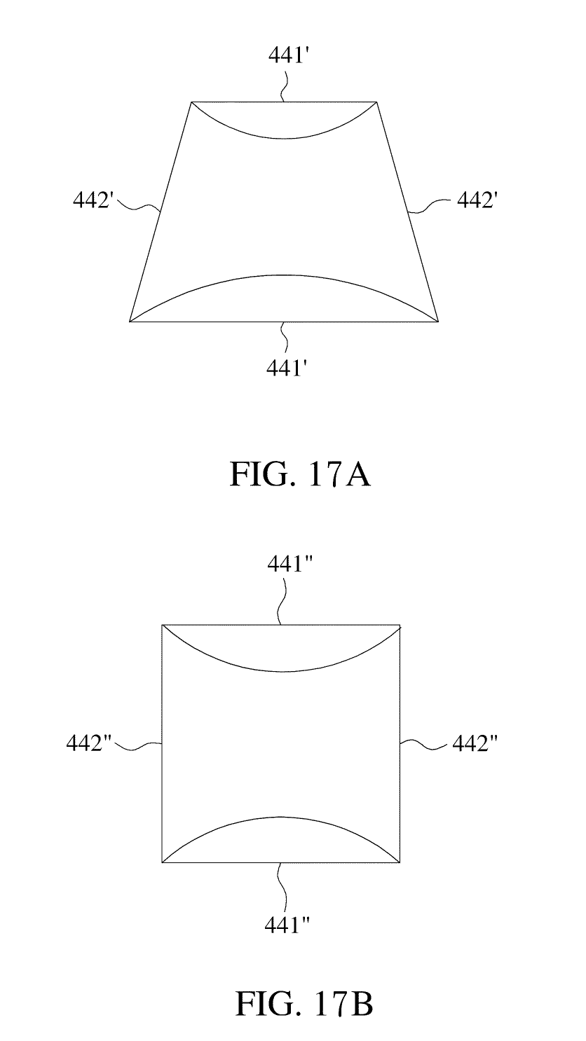

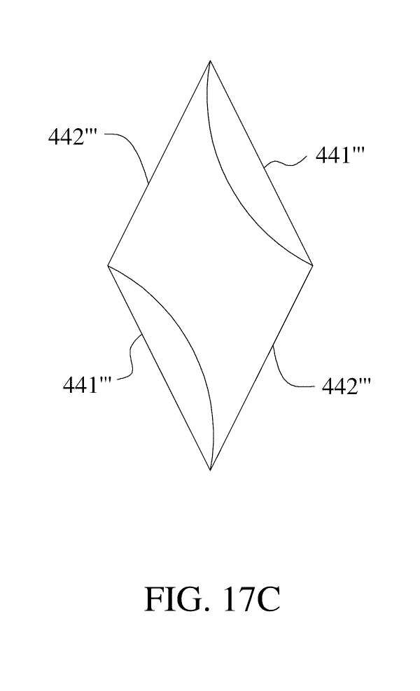

Note that the area defined by two first sides 441 and two second sides 442 is rectangular in the present concave structure 44. However, those skilled in the art can modify the area into other shape as needed. For example, as shown in FIG. 17A, the area defined by two first sides 441′ and two second sides 442′ is trapezoid. In addition, as shown in FIG. 17B, the area defined by two first sides 441″ and two second sides 442″ is square. Furthermore, as shown in FIG. 17C, the area defined by two first sides 441′″ and two second sides 442′″ is diamond.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A diffusion plate, comprising a structured surface, which has pluralities of concave structures disposed thereon, wherein each concave structure, with at least two opposite first sides and at least two opposite second sides, comprises at least two first curved surfaces and at least two second curved surfaces, while the first curved surfaces and the second curved surfaces are extended from the first sides and the second sides respectively; each concave structure adjoins at least one other concave structure, and the shape of a neighboring portion of two said adjoining concave structures is curved.

2. The diffusion plate according to claim 1, wherein an area defined by said first sides and said second sides is trapezoid, rectangular, diamond or square.

3. The diffusion plate according to claim 1, wherein the first curved surfaces and the second curved surfaces intersect to form an intersection point.

4. The diffusion plate according to claim 1, wherein each concave structure further comprises a bottom surface, which is connected with the first curved surfaces and the second curved surfaces.

5. The diffusion plate according to claim 4, wherein the bottom surface is flat or curved.

6. The diffusion plate according to claim 1, further comprising a body disposed under the structured surface, wherein there are pluralities of light diffusion particles, which the refractive index thereof is different from that of the body, spread therein.

7. The diffusion plate according to claim 6, further comprising a substrate disposed under the body, wherein UV absorber is added therein.

8. The diffusion plate according to claim 1, wherein two said first curved surfaces are symmetric, and two said second curved surfaces are symmetric.

9. A diffusion plate, comprising a structured surface, which has pluralities of concave structures disposed thereon, wherein each concave structure, with at least two opposite first sides and at least two opposite second sides, comprises a first curved surface and two second curved surfaces, while two said second curved surfaces are extended from two said first sides respectively and both sides of the first curved surface are connected to two said second surfaces respectively; each concave structure adjoins at least one other concave structure, and the shape of a neighboring portion of two adjoining concave structures is curved.

10. The diffusion plate according to claim 9, wherein an area defined by said first sides and said second sides is trapezoid, rectangular, diamond or square.

11. The diffusion plate according to claim 9, further comprising a body disposed under the structured surface, wherein there are pluralities of light diffusion particles, which the refractive index thereof is different from that of the body, spread therein.

12. The diffusion plate according to claim 9, further comprising a substrate disposed under the body, wherein UV absorber is added therein.

13. The diffusion plate according to claim 9, wherein two said second curved surfaces are symmetric.
